(19) United States
(12) Patent Application Publication
(10) Pub. No.: US 2021/0319149 A1
(43) Pub. Date: Oct. 14, 2021

(54) METHOD, DEVICE, EQUIPMENT AND STORAGE MEDIUM FOR GENERATING THREE-DIMENSIONAL SPACE OF TARGET HOUSE

(71) Applicant: BEIJING CHENGSHI WANGLIN INFORMATION TECHNOLOGY CO., LTD., Beijing (CN)

(72) Inventors: Juyan WANG, Beijing (CN); Yu ZHOU, Beijing (CN); Shuangshuang LIU, Beijing (CN); Peiwen GAO, Beijing (CN)

(21) Appl. No.: 17/228,638

(22) Filed: Apr. 12, 2021

(30) Foreign Application Priority Data
Feb. 10, 2020 (CN) 202010084409.1

(51) Int. Cl. G06F 30/13; G06F 30/23; G06T 19/20

(52) U.S. Cl. CPC G06F 30/13; G06T 19/20; G06F 30/23

(57) ABSTRACT

The disclosure provides a method, a device, an equipment and a storage medium for generating a three-dimensional space of a target house. The method for generating the three-dimensional space of the target house comprises: acquiring a two-dimensional floor plan of the target house corresponding to the displayed real three-dimensional floor plan scene, wherein the two-dimensional floor plan includes at least one area; for each area of the at least one area, determining wall body information corresponding to the area; constructing a three-dimensional subspace corresponding to the area based on the wall body information corresponding to the area; and generating a three-dimensional space corresponding to the target house based on the two-dimensional floor plan and the three-dimensional subspace corresponding to each area of the at least one area.

### CROSS-REFERENCE TO RELATED APPLICATION

This application claims the priority of Chinese Patent Application No. 202010084409.1, filed on Feb. 10, 2020, in the China National Intellectual Property Administration, the entire contents of which are herein incorporated by reference.

### TECHNICAL FIELD

The disclosure relates to the technical field of data processing, and in particular, relates to a method, a device, an equipment and a storage medium for generating a three-dimensional space of a target house.

### BACKGROUND

At present, Virtual Reality (VR) is a new practical technology. The VR technology generates a virtual scene of a three-dimensional space through computer simulation, and provides users with a simulation of visual, auditory and tactile senses, thus offering users an immersive experience of observing things in the three-dimensional space. With the constant development of social productivity, science and technology, the VR technology is increasingly needed in various fields. For example, VR technology can be applied to a space (such as buildings, etc.) display system. Based on the VR technology, a realistic 3D model of buildings can be created, and the structures and functions of the interior and exterior of buildings can be fully displayed, so that users can roam through the 3D model of the buildings through the network, and feel the buildings and their surrounding environment as they are there, thereby realizing remote viewing and house selection quickly and conveniently.

### SUMMARY

According to one aspect of the disclosure, a method for generating a three-dimensional space of a target house is provided, comprising the following steps: acquiring a two-dimensional floor plan of a target house corresponding to a displayed real three-dimensional floor plan scene, wherein the two-dimensional floor plan includes at least one area; for each area of the at least one area, determining wall body information corresponding to the area; constructing a three-dimensional subspace corresponding to the area based on the wall body information corresponding to the area; and generating a three-dimensional space corresponding to the target house based on the two-dimensional floor plan and the three-dimensional subspace corresponding to each area of the at least one area.

According to an embodiment of the disclosure, the wall body information corresponding to the area includes: thickness information and height information of a wall body which constitutes a three-dimensional subspace corresponding to the area, and the constructing a three-dimensional subspace corresponding to the area based on the wall body information corresponding to the area includes: constructing a three-dimensional subspace corresponding to the area based on the thickness information and height information of the wall body which constitutes the three-dimensional subspace.

According to an embodiment of the present disclosure, the constructing the three-dimensional subspace corresponding to the area includes: for each wall body for defining the three-dimensional subspace, the three-dimensional vertex coordinates of the wall body in a three-dimensional coordinate system are determined based on the thickness information and height information of the wall body.

According to an embodiment of the present disclosure, the constructing the three-dimensional subspace corresponding to the area further includes: acquiring hollow data of a hollow in the three-dimensional subspace, wherein the hollow data includes height, size and attachment information of the hollow; determining an attached wall body where the hollow is located in the three-dimensional subspace based on the attachment information of the hollow; and establishing three-dimensional vertex coordinates of the hollow in the three-dimensional coordinate system based on the three-dimensional vertex coordinates of the determined attached wall body and the height and size of the hollow, wherein the hollow is at least one of the following: a door, a window and a television wall.

According to an embodiment of the present disclosure, the two-dimensional floor plan includes an independent area, and the generating a three-dimensional space corresponding to the target house based on the two-dimensional floor plan and the three-dimensional subspace corresponding to each area of the at least one area includes: determining the three-dimensional subspace corresponding to the independent area as the three-dimensional space.

According to an embodiment of the present disclosure, the two-dimensional floor plan includes a plurality of areas, and the generating a three-dimensional space corresponding to the target house based on the two-dimensional floor plan and the three-dimensional subspace corresponding to each area of the at least one area includes: determining adjacent first area and second area for the plurality of areas, wherein the adjacent first area and second area share a connecting wall body; and splicing the three-dimensional subspace corresponding to the first area and the three-dimensional subspace corresponding to the second area based on the connecting wall body to generate a three-dimensional space corresponding to the target house.

According to an embodiment of the disclosure, the method further comprises: acquiring wall surface decoration information; and setting attribute information of the wall surface in the three-dimensional space as an updated three-dimensional floor plan scene of the target house based on the wall surface decoration information, wherein the wall surface decoration information includes: wall surface information and decoration information, and the wall surface information is used for indicating the wall surface to which the decoration information is applied.

According to an embodiment of the disclosure, the method further comprises: acquiring furniture decoration information; and setting arrangement information of furniture in the three-dimensional space as an updated three-dimensional floor plan scene of the target house based on the furniture decoration information, wherein the furniture decoration information includes: furniture coordinate information and furniture style information.

According to an embodiment of the present disclosure, the method further comprises: acquiring furniture operation information; and performing an operation on the furniture corresponding to the furniture operation information as an updated three-dimensional floor plan scene of the target house based on the furniture operation information, wherein the operation comprises at least one of: deletion, movement and replacement.

According to an embodiment of the present disclosure, the method further comprises: storing the data of the updated three-dimensional floor plan scene of the target house.

According to another aspect of the present disclosure, it is also provided a device for generating a three-dimensional space of a target house, which comprises: an acquiring unit, configured to acquire a two-dimensional floor plan of the target house corresponding to the displayed real three-dimensional floor plan scene, wherein the two-dimensional floor plan includes at least one area; a determining unit, configured to determine, for each area of the at least one area, wall body information corresponding to the area; a constructing unit, configured to construct a three-dimensional subspace corresponding to the area based on the wall body information corresponding to the area; and a generating unit, configured to generate a three-dimensional space corresponding to the target house based on the two-dimensional floor plan and the three-dimensional subspace corresponding to each area of the at least one area.

According to an embodiment of the present disclosure, the wall body information corresponding to the area includes: thickness information and height information of a wall body which constitutes a three-dimensional subspace corresponding to the area, wherein the construction unit is configured to construct a three-dimensional subspace corresponding to the area based on the thickness information and height information of the wall body which constitutes the three-dimensional subspace.

According to an embodiment of the present disclosure, the construction unit constructing the three-dimensional subspace corresponding to the area includes: for each wall body for defining the three-dimensional subspace, determining three-dimensional vertex coordinates of the wall body in a three-dimensional coordinate system based on thickness information and height information of the wall body.

According to an embodiment of the disclosure, the construction unit is further configured to: acquire hollow data of a hollow in the three-dimensional subspace, wherein the hollow data includes height, size and attachment information of the hollow; determine attached wall body where the hollow is located in the three-dimensional subspace based on attachment information of the hollow; and establish three-dimensional vertex coordinates of the hollow in the three-dimensional coordinate system based on the three-dimensional vertex coordinates of the determined attached wall body and the height and size of the hollow, wherein the hollow is at least one of the following: a door, a window and a television wall.

According to an embodiment of the present disclosure, the two-dimensional floor plan includes an independent area, and the generating unit is configured to: determine the three-dimensional subspace corresponding to the independent area as the three-dimensional space.

According to an embodiment of the present disclosure, the two-dimensional floor plan includes a plurality of areas, and the generating unit is configured to: determine adjacent first area and second area for the plurality of areas, wherein the adjacent first area and second area share a connecting wall body body; and splice the three-dimensional subspace corresponding to the first area and the three-dimensional subspace corresponding to the second area based on the connecting wall body body to generate a three-dimensional space corresponding to the target house.

According to an embodiment of the disclosure, the device further comprises a wall surface decoration unit configured to: acquire wall surface decoration information; and set attribute information of a wall surface in the three-dimensional space as an updated three-dimensional floor plan scene of the target house based on the wall surface decoration information, wherein the wall surface decoration information includes: wall surface information and decoration information, and the wall surface information is used for indicating the wall surface to which the decoration information is applied.

According to an embodiment of the present disclosure, the device further includes a furniture decoration unit configured to: acquire furniture decoration information; and set arrangement information of furniture in the three-dimensional space as an updated three-dimensional floor plan scene of the target house based on the furniture decoration information, wherein the furniture decoration information includes: furniture coordinate information and furniture style information.

According to an embodiment of the present disclosure, the device further includes a furniture operation unit configured to: acquire furniture operation information; and perform an operation on furniture corresponding to the furniture operation information as an updated three-dimensional floor plan scene of the target house based on the furniture operation information, wherein the operation comprises at least one of: deletion, movement and replacement.

According to an embodiment of the present disclosure, the device further includes a storage unit configured to store data of the updated three-dimensional floor plan scene of the target house.

According to another aspect of the present disclosure, it is also provided an equipment for decorating the three-dimensional floor plan scene, comprising: one or more processors; and one or more memories, wherein computer readable codes are stored in the memories, and when the computer readable codes are run by the one or more processors, the computer readable codes execute the method for decorating the three-dimensional floor plan scene as described above.

According to yet another aspect of the present disclosure, it is also provided a computer readable storage medium where instructions are stored, and when the instructions are executed by a processor, the method for decorating a three-dimensional floor plan scene as described above is executed by the processor.

### BRIEF DESCRIPTION OF DRAWINGS

In order to explain the embodiments of the present disclosure or the technical solutions in the prior art more clearly, the drawings required in the embodiments or the technical description of the prior art will be briefly introduced below. Obviously, the drawings described below are only in part of the embodiments of the present disclosure, and for those of ordinary skills in the art, other drawings may be acquired according to these drawings without paying creative labor.

FIG. 1 illustrates a schematic flowchart of a method for generating a three-dimensional space of a target house according to an embodiment of the present disclosure;

FIG. 2 illustrates a schematic diagram of a two-dimensional floor plan;

FIG. 3 illustrates a schematic diagram of three-dimensional vertex coordinates of a wall body according to an embodiment of the present disclosure;

FIG. 4 illustrates a schematic diagram of arranging furniture based on furniture decoration information according to an embodiment of the present disclosure;

FIG. 5 illustrates a schematic block diagram of a device for generating a three-dimensional space of a target house according to an embodiment of the present disclosure;

FIG. 6 illustrates a schematic block diagram of an equipment for generating a three-dimensional space of a target house according to an embodiment of the present disclosure;

FIG. 7 illustrates a schematic diagram of a construction of an exemplary computing equipment according to an embodiment of the present disclosure; and

FIG. 8 illustrates a schematic diagram of a storage medium according to an embodiment of the present disclosure.

### DETAILED DESCRIPTION

In order to make the purpose, technical scheme and advantages of the embodiments of the present disclosure clearer, the technical scheme of the embodiments of the present disclosure will be described clearly and completely with reference to the drawings of the embodiments of the present disclosure. Obviously, the described embodiments are part of embodiments of the present disclosure, but not all embodiments. Based on the described embodiments of the present disclosure, all other embodiments acquired by those of ordinary skills in this field without paying creative labor belong to the scope of protection of the present disclosure.

Unless otherwise defined, technical terms or scientific terms used in the present disclosure shall have the ordinary meaning that can be understood by those with ordinary skills in the field to which this disclosure belongs. As used in the present disclosure, “first”, “second” and other similar words do not indicate any order, quantity or importance, but are only used to distinguish different parts. “Include”, “comprise” or other similar words mean that the elements or objects before the word cover the listed elements or objects after the word and their equivalents, but do not exclude other elements or objects. “Connect”, “connecting” or similar words are not limited to physical or mechanical connection, but may include electrical connection, whether direct or indirect. “Upper”, “lower”, “left” and “right”, etc., are only used to represent relative positional relationship. When the absolute position of the described object changes, the relative positional relationship may change accordingly. In order to make the following description of the embodiments of the present disclosure clear and concise, detailed descriptions of part of the known functions and known components are omitted in the present disclosure.

A flowchart is used in the present disclosure to illustrate the steps of the method according to an embodiment of the disclosure. It should be understood that the preceding or following steps are not necessarily performed accurately in order. On the contrary, the various steps may be processed in reverse order or simultaneously. At the same time, other operations may be added to these procedures, or one step or several steps may be removed from these procedures.

Based on the stereoscopic display technology such as VR and Augmented Reality, the stereoscopic display of houses can be realized. The stereoscopic display of the house scene can make it more convenient for users who are about to buy a house or rent a house, etc., to view the overall effect of the house online, and as the remote viewing is realized, the inconvenience caused by on-site viewing is avoided, and the rush between different areas is also avoided.

The three-dimensional scene of the target house displayed to the user may be a real three-dimensional floor plan scene of the target house, wherein image data in the real three-dimensional floor plan scene is generated based on the real image of the target house. As an example, for a new house, a second-hand house (which has been renovated) or a roughcast house (which has not been decorated) that needs to be displayed, a stereo camera may be used to acquire the real image of the house, and a real three-dimensional floor plan scene of the target house can be generated based on the real image. In other words, the real three-dimensional floor plan scene displays the current state of the target house in a stereoscopic way.

Further, in addition to viewing the house, the user may also operate the target house online in the stereoscopic display, such as redecorating the renovated second-hand house. As an example, the user can place furniture in the living room of the displayed target house through a terminal equipment or a computer. Through the virtual decoration in the stereoscopic scene of the displayed target house, the user can preview the renovation effect in advance, so as to avoid the problems such as the renovation effect being not ideal or the furniture size not matching after the actual renovation is completed.

In order to realize the operation of renovating and decorating the target house, it is necessary to generate a three-dimensional space of the target house to realize the operations in the constructed three-dimensional space. For example, the three-dimensional space may be constructed based on the real data of the target house, so that decoration operation can be performed in the three-dimensional space constructed based on the real house data to show the display effect after redecoration.

Therefore, the present disclosure provides a method for generating a three-dimensional space of a target house, so as to construct a three-dimensional space of the target house based on a two-dimensional floor plan of the target house and wall body information. In the three-dimensional space provided based on the method of the present disclosure, for example, the user can decorate and renovate the target house and view the effect after the operations. As an application example, in the process of purchasing a second-hand house, the user can view the displayed real three-dimensional floor plan scene of the target house, and decorate the three-dimensional space of the target house, so as to view the possible decorated effect before purchasing the house, which is helpful for users to choose their favorite house, and increases the practicality and interest of house selection.

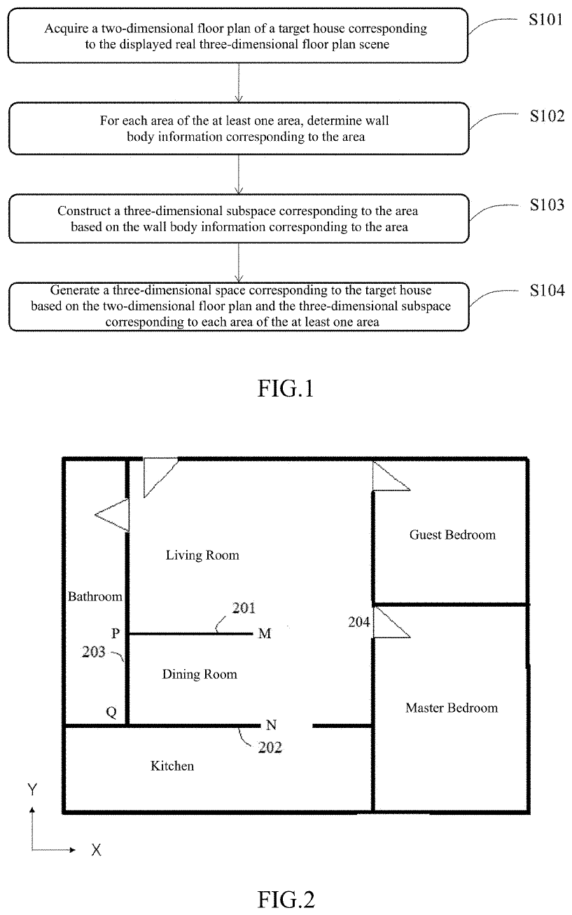

FIG. 1 illustrates a schematic flowchart of a method for generating a three-dimensional space of a target house according to an embodiment of the present disclosure. As shown in FIG. 1, at first, at step S101, a two-dimensional floor plan of the target house corresponding to the displayed real three-dimensional floor plan scene is acquired. For example, the real three-dimensional floor plan scene can be used to reflect the current decoration state of the target house.

According to an embodiment of the present disclosure, the two-dimensional floor plan includes at least one area, and for example, the two-dimensional floor plan may include an independent area, which may correspond to the situation of independent rooms, or for example, the two-dimensional floor plan may also include more than two areas, the number of which is not limited here. FIG. 2 illustrates a schematic diagram of a two-dimensional floor plan. As shown in FIG. 2, the floor plan includes a plurality of areas corresponding to a living room, a dining room, a kitchen, a master bedroom, a guest bedroom and a bathroom.

As further shown in FIG. 1, at step S102, for each area of the at least one area, wall body information corresponding to the area is determined. And, at step S103, based on the wall body information corresponding to the area, a three-dimensional subspace corresponding to the area is constructed. In the disclosure, the area represents a two-dimensional range, which can be understood as a planar area; and the three-dimensional subspace, three-dimensional space, etc. are used to represent a three-dimensional range, which can be understood as a stereoscopic area such as a cube.

For convenience of description and intuitive display, the constructing process of the three-dimensional space corresponding to the two-dimensional floor plan is described in this disclosure in combination with the two-dimensional floor plan shown in FIG. 2. As the coordinate system shown in the lower left corner of FIG. 2, the three-dimensional space may take the transverse direction as the x coordinate axis and the longitudinal direction as the y coordinate axis. In addition, the positive direction of the z coordinate axis may be the outward direction perpendicular to the paper surface. It should be noted that the two-dimensional floor plan shown in FIG. 2 is only taken as an example, and the method according to the present disclosure can be applied to any other floor plan structure, which is not limited here.

For each area in the floor plan, a three-dimensional subspace corresponding to the area can be constructed. For example, taking a dining room area shown in FIG. 2 as a specific example, a dining room subspace corresponding to the dining room area may be constructed. Similarly, for the floor plan shown in FIG. 2, a living room subspace corresponding to a living room area, a master bedroom subspace corresponding to a master bedroom area, a guest bedroom subspace corresponding to a guest bedroom area, a kitchen subspace corresponding to a kitchen area, etc, may be constructed. For example, the subspace (dining room subspace) corresponding to the dining room in the three-dimensional space of the target house corresponds to the area (dining room area) corresponding to the dining room in the two-dimensional floor plan.

Then, as shown in FIG. 1, at step S104, a three-dimensional space corresponding to the target house is generated based on the two-dimensional floor plan and the three-dimensional subspace corresponding to each area of the at least one area. The specific process in this step will be described in detail below.

Next, the detailed process of building the three-dimensional subspace based on wall body information will be introduced.

According to an embodiment of the present disclosure, the wall body information corresponding to the area includes: thickness information and height information of a wall body which constitutes a three-dimensional subspace corresponding to the area. The constructing a three-dimensional subspace corresponding to the area based on the wall body information corresponding to the area includes: a three-dimensional subspace corresponding to the area is constructed based on the thickness information and height information of the wall body which constitutes the three-dimensional subspace. The constructing the three-dimensional subspace corresponding to the area includes: for each wall body for defining the three-dimensional subspace, determining three-dimensional vertex coordinates of the wall body in a three-dimensional coordinate system based on the thickness information and height information of the wall body.

For example, taking the dining room area shown in FIG. 2 as an example, the process of constructing a dining room three-dimensional subspace corresponding to the dining room area will be explained. As shown in FIG. 2, the dining room area may include three wall lines, for example, wall lines 201-203, for defining its area. From a stereoscopic view, the wall lines of the dining room area may correspond to the wall body of the dining room three-dimensional subspace.

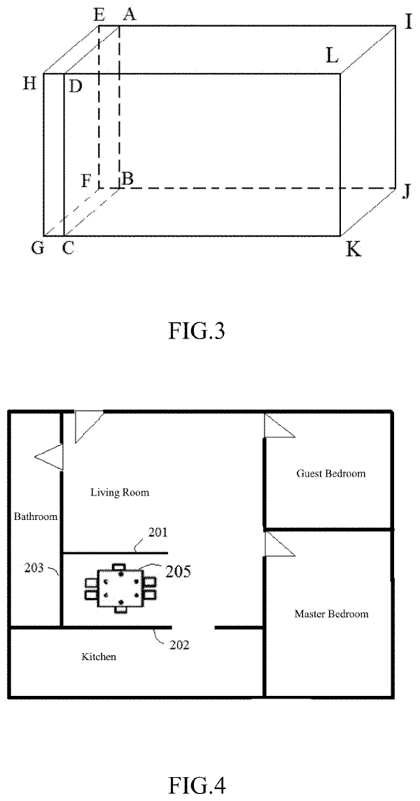

FIG. 3 illustrates a schematic diagram of three-dimensional vertex coordinates of a wall body according to an embodiment of the present disclosure. As shown in FIG. 3, the interior side of the dining room three-dimensional subspace may be defined by points A, B, C, D, I, J, K and L, wherein points B, C, J and K may correspond to the dining room area defined by points M, N, P and Q in FIG. 2. In addition, a cube composed of eight vertexes from point A to point H in FIG. 3 may represent a wall body corresponding to the above-mentioned wall line 203 in FIG. 2 in the dining room three-dimensional subspace, and the wall body may be presented as a wall body 203. In FIG. 3, the first vertex B and the second vertex C represent vertexes of the wall body on the ground near the three-dimensional subspace side, and the third vertex A and the fourth vertex D represent vertexes of the wall body on the top surface near the three-dimensional subspace side, the fifth vertex F and the sixth vertex G represent vertexes of the wall body on the ground away from the three-dimensional subspace side, and the seventh vertex E and the eighth vertex H represent vertexes of the wall body on the top surface away from the three-dimensional subspace side. As mentioned above, the three-dimensional coordinate system of the three-dimensional subspace in FIG. 3 takes the ground plane in the two-dimensional floor plan as the XY plane, and takes the outward direction perpendicular to the paper surface as the Z axis.

For example, through the wall line 203 in the dining room area, its wall body information can be determined, and the wall body information includes thickness information and height information of the wall body 203 corresponding to the wall line 203. Based on the thickness information and the height information, eight three-dimensional vertex coordinates of a cube which represents the wall body 203 can be determined, i.e., the three-dimensional coordinate of each vertex from point A to point H. For example, the thickness information can represent the distance between point C and point G, and the height information can represent the distance between point D and point C. In the above-mentioned manner, the wall body 203 can be determined in the three-dimensional coordinate system. The constructed wall body 203 is presented as a cube having a thickness. Similarly, the three-dimensional vertex coordinates of other wall bodies in the dining room three-dimensional subspace can also be determined, such as a wall body 201 corresponding to the wall line 201 and a wall body 202 corresponding to the wall line 202. In addition, there is no wall line for defining the right boundary line of the dining room area, and in this case, there is no wall body for defining the right boundary plane of the dining room three-dimensional subspace.

According to the process described above, for each area of at least one area included in the two-dimensional floor plan of the target house, a three-dimensional subspace corresponding to the area can be constructed, and further, a three-dimensional space corresponding to the target house can be generated based on the constructed three-dimensional subspace.

According to an embodiment of the present disclosure, the two-dimensional floor plan includes an independent area, and in other words, the target house only includes one independent area. In this embodiment, generating a three-dimensional space corresponding to the target house based on the two-dimensional floor plan and the three-dimensional subspace corresponding to each area of the at least one area includes: determining the three-dimensional subspace corresponding to the independent area as the three-dimensional space, i.e., the three-dimensional subspace of the independent area is directly determined as the three-dimensional space of the target house.

According to another embodiment of the present disclosure, the two-dimensional floor plan includes a plurality of areas, for example, a plurality of areas shown in FIG. 2. In this embodiment, the generating a three-dimensional space corresponding to the target house based on the two-dimensional floor plan and the three-dimensional subspace corresponding to each area of the at least one area includes: determining adjacent first area and second area for the plurality of areas, wherein the adjacent first area and second area share a connecting wall body; and splicing the three-dimensional subspace corresponding to the first area and the three-dimensional subspace corresponding to the second area based on the connecting wall body to generate a three-dimensional space corresponding to the target house.

For example, as shown in FIG. 2, it can be determined that the dining room area is adjacent to the bathroom area based on the wall line 203, i.e., the wall line 203 is used to define both the boundary of the dining room area and the partial boundary of the bathroom area. The dining room area may correspond to the first area, and the bathroom area may correspond to the second area, and the dining room area and the bathroom area are connected by the wall line 203. In other words, the two adjacent areas can be determined based on the shared wall line in the two-dimensional floor plan. Similarly, the dining room three-dimensional subspace and the bathroom three-dimensional subspace are connected by the wall body 203, i.e., the wall body 203 can be used as the shared connecting wall body. Then, after the connecting wall body 203 is determined, the three-dimensional subspace corresponding to the first area (i.e., dining room area) and the three-dimensional subspace corresponding to the second area (i.e., bathroom area) can be spliced to generate the three-dimensional space. For example, the vertex coordinates of the part of the connecting wall body shared by the dining room three-dimensional subspace and the bathroom three-dimensional subspace can be presented as the same.

According to an embodiment of the present disclosure, the constructing the three-dimensional subspace corresponding to the area further includes: acquring hollow data of a hollow in the three-dimensional subspace, wherein the hollow data includes height, size and attachment information of the hollow; determining an attached wall body where the hollow is located in the three-dimensional subspace based on the attachment information of the hollow; and establishing three-dimensional vertex coordinates of the hollow in the three-dimensional coordinate system based on the three-dimensional vertex coordinates of the determined attached wall body and the height and size of the hollow, wherein the hollow is at least one of: a door, a window and a television wall.

For example, the master bedroom area shown in FIG. 2 includes a door 204. According to an embodiment of the present disclosure, hollow data of the door 204, such as its height, size and attachment information, can be acquired. As an example, the height may be presented as the distance between the center point of the door 204 and the ground, and the size of the door 204 may be presented by the length and width of the door 204. In addition, the attachment information represents the attached wall body where the door 204 is located in the master bedroom three-dimensional subspace, and may also include attachment location. For example, based on the attachment information of the door 204, it can be determined that the door 204 is located on the left wall body of the master bedroom three-dimensional subspace and at its location on the left wall body. Specifically, based on the hollow data of the door 204, a cube corresponding to the door 204 can be determined in the left wall body of the master bedroom three-dimensional subspace. For example, the cube corresponding to the door 204 can be uniquely determined by eight vertex coordinates.

According to the process described above, a three-dimensional space corresponding to the target house can be generated in the form of three-dimensional vertex coordinates, wherein structures such as wall bodies and hollows are determined by the three-dimensional vertex coordinates in the three-dimensional coordinate system. In other words, according to the method of the present disclosure, a three-dimensional space presented in the form of a plurality of vertex coordinates can be generated. Based on the generated three-dimensional space, virtual decoration, renovation and other operations can be performed on the target house. The above virtual operations can be understood as arranging in the three-dimensional space.

According to an embodiment of the present disclosure, the method may further include: acquiring wall surface decoration information; and setting attribute information of a wall surface in the three-dimensional space as an updated three-dimensional floor plan scene of the target house based on the wall surface decoration information, wherein the wall surface decoration information includes: wall surface information and decoration information, and the wall surface information is used for indicating the wall surface to which the decoration information is applied.

For example, the wall surface decoration information may include wall surface information indicating the wall surface to which the decoration information is applied and decoration information. As an example, in the case that a wall surface determined by point A, point B, point C and point D as shown in FIG. 2 needs to be decorated, the wall surface information may include an identification of the wall surface, and the decoration information may include specific decoration contents, such as patterns, colors, etc. which can characterize wallpaper. The wall surface can be decorated by setting attribute information of the wall surface based on the wall surface decoration information. Further, compared with the above-mentioned real three-dimensional floor plan scene, the decorated three-dimensional space can be used as an updated three-dimensional floor plan scene of the target house.

According to an embodiment of the present disclosure, the method may further include: acquring furniture decoration information; and setting arrangement information of furniture in the three-dimensional space as an updated three-dimensional floor plan scene of the target house based on the furniture decoration information, wherein the furniture decoration information includes: furniture coordinate information and furniture style information.

FIG. 4 illustrates a schematic diagram of arranging furniture based on furniture decoration information according to an embodiment of the present disclosure. For example, for a table furniture 205 set in the dining room area in FIG. 4, its furniture decoration information may include information of a coordinate where the table furniture needs to be set and furniture style information corresponding to the table furniture. Herein the coordinate information may include the three-dimensional coordinate of the center point of the furniture, which is used to determine the location of the furniture in the three-dimensional space, and the furniture style information may include identification of the dining table furniture, which is used to represent that the dining table furniture corresponding to the identification is placed at the location determined by the coordinate information. According to the embodiments of the present disclosure, a furniture style database may also be constructed in advance for storing information of furniture with different styles and sizes, such as a dining table, a wardrobe, a dressing table, etc. In case furniture decoration is needed in the three-dimensional space, the furniture in the furniture style database can be screened, and the selected furniture can be added into the three-dimensional space. The location where the furniture is to be added, i.e., the coordinate information, can be directly input by the user, or by means of mouse click, touch click, button, etc., which is not limited here.

According to an embodiment of the present disclosure, the method may further include: acquring furniture operation information; and based on the furniture operation information, operating furniture corresponding to the furniture operation information as an updated three-dimensional floor plan scene of the target house, wherein the operation comprises at least one of: deletion, movement and replacement.

For example, after adding the dining table 205 as shown in FIG. 4, the added furniture can be further operated, such as moving it to other locations, replacing it with other furniture, or deleting it. As an example, the above operations can be performed by the user in the displayed updated three-dimensional floor plan scene, and for example, the dining table 205 can be selected and dragged into other three-dimensional subspaces. The specific operations of decorating and renovating the three-dimensional space will not be exemplified with examples.

According to an embodiment of the present disclosure, the method may further include: storing the updated data of the three-dimensional floor plan scene of the target house. The storing may only include storing data related to the three-dimensional space, decoration and renovation, such as vertex coordinates which constitute the three-dimensional space, the above-mentioned wall surface decoration information, furniture decoration information, etc. Compared with storing the whole updated three-dimensional floor plan scene after decoration, this storing method can reduce the data storage quantity and reduce the demand for the storage capacity and processing capacity of a hardware equipment. In case that the decorated three-dimensional space needs to be displayed again, the three-dimensional floor plan scene can be displayed according to the stored data.

According to the method provided by the present disclosure, the three-dimensional space corresponding to the target house can be generated based on the two-dimensional floor plan and wall body information of the target house corresponding to the displayed real three-dimensional floor plan scene. The three-dimensional space can be used as a basic framework for realizing the decoration and renovation of the target house, so as to realize the purpose of virtual decoration of the target house.

A device for generating a three-dimensional space of a target house is also provided by the present disclosure. FIG. 5 illustrates a schematic block diagram of a device for decorating a three-dimensional floor plan scene according to an embodiment of the present disclosure. As shown in FIG. 5, the device 1000 for generating a three-dimensional space of a target house may include an acquiring unit 1010, a determining unit 1020, a constructing unit 1030 and a generating unit 1040.

According to an embodiment of the present disclosure, the acquiring unit 1010 may be configured to: acquire a two-dimensional floor plan of the target house corresponding to the displayed real three-dimensional floor plan scene, wherein the two-dimensional floor plan includes at least one area. The determining unit 1020 may be configured to determine, for each area of the at least one area, wall body information corresponding to the area. The constructing unit 1030 may be configured to construct a three-dimensional subspace corresponding to the area based on the wall body information corresponding to the area. The generating unit 1040 may be configured to generate a three-dimensional space corresponding to the target house based on the two-dimensional floor plan and the three-dimensional subspace corresponding to each area of the at least one area.

According to an embodiment of the present disclosure, the wall body information corresponding to the area includes: thickness information and height information of a wall which constitutes a three-dimensional subspace corresponding to the area, wherein the constructing unit 1030 is configured to construct a three-dimensional subspace corresponding to the area based on the thickness information and height information of the wall which constitutes the three-dimensional subspace.

According to an embodiment of the present disclosure, the constructing unit 1030 constructing the three-dimensional subspace corresponding to the area includes: for each wall body for defining the three-dimensional subspace, determining three-dimensional vertex coordinates of the wall body in a three-dimensional coordinate system based on the thickness information and height information of the wall body.

According to an embodiment of the present disclosure, the constructing unit 1030 may be further configured to: acquire hollow data of a hollow in the three-dimensional subspace, wherein the hollow data includes height, size and attachment information of the hollow; determine an attached wall body where the hollow is located in the three-dimensional subspace based on the attachment information of the hollow; and establish three-dimensional vertex coordinates of the hollow in the three-dimensional coordinate system based on the three-dimensional vertex coordinates of the determined attached wall body and the height and size of the hollow, wherein the hollow is at least one of: a door, a window and a television wall.

According to an embodiment of the present disclosure, the two-dimensional floor plan includes an independent area, and the generating unit 1040 may be configured to: determine the three-dimensional subspace corresponding to the independent area as the three-dimensional space.

According to an embodiment of the present disclosure, the two-dimensional floor plan includes a plurality of areas, and the generating unit 1040 may be configured to: determine adjacent first area and second area for the plurality of areas, wherein the adjacent first area and second area share a connecting wall body; and splice the three-dimensional subspace corresponding to the first area and the three-dimensional subspace corresponding to the second area based on the connecting wall body to generate a three-dimensional space corresponding to the target house.

As shown in FIG. 5, according to an embodiment of the present disclosure, the device 1000 may further include a wall surface decoration unit 1050. The wall surface decoration unit 1050 may be configured to: acquire wall surface decoration information; set attribute information of a wall surface in the three-dimensional space as an updated three-dimensional floor plan scene of the target house based on the wall surface decoration information, wherein the wall surface decoration information includes: wall surface information and decoration information, and the wall surface information is used for indicating the wall surface to which the decoration information is applied.

As shown in FIG. 5, according to an embodiment of the present disclosure, the device 1000 may further include a furniture decoration unit 1060. The furniture decoration unit 1060 may be configured to: acquire furniture decoration information; set arrangement information of furniture in the three-dimensional space as an updated three-dimensional floor plan scene of the target house based on the furniture decoration information, wherein the furniture decoration information includes: furniture coordinate information and furniture style information.

As shown in FIG. 5, according to an embodiment of the present disclosure, the device 1000 may further include a furniture operation unit 1070. The furniture operation unit 1070 may be configured to: acquire furniture operation information; perform an operation on furniture corresponding to the furniture operation information as an updated three-dimensional floor plan scene of the target house based on the furniture operation information, wherein the operation includes at least one of: deletion, movement and replacement.

According to an embodiment of the present disclosure, the device 1000 may further include a storage unit 1080. The storage unit 1080 may be configured to store data of the updated three-dimensional floor plan scene of the target house.

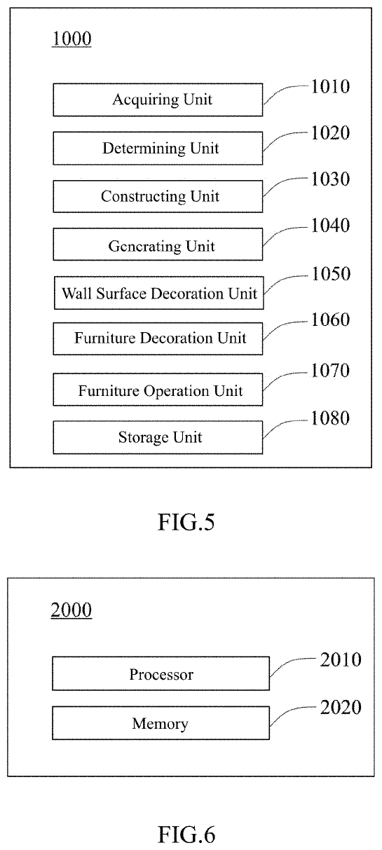

According to another aspect of the present disclosure, it is also provided an equipment for generating a three-dimensional space of a target house. FIG. 6 illustrates a schematic block diagram of an equipment for decorating a three-dimensional floor plan scene according to an embodiment of the present disclosure.

As shown in FIG. 6, the equipment 2000 may include one or more processors 2010 and one or more memories 2020. Herein computer readable codes are stored in the memory 2020, and when run by the one or more processors 2010, the computer readable codes can execute the method for generating a three-dimensional space of a target house as described above.

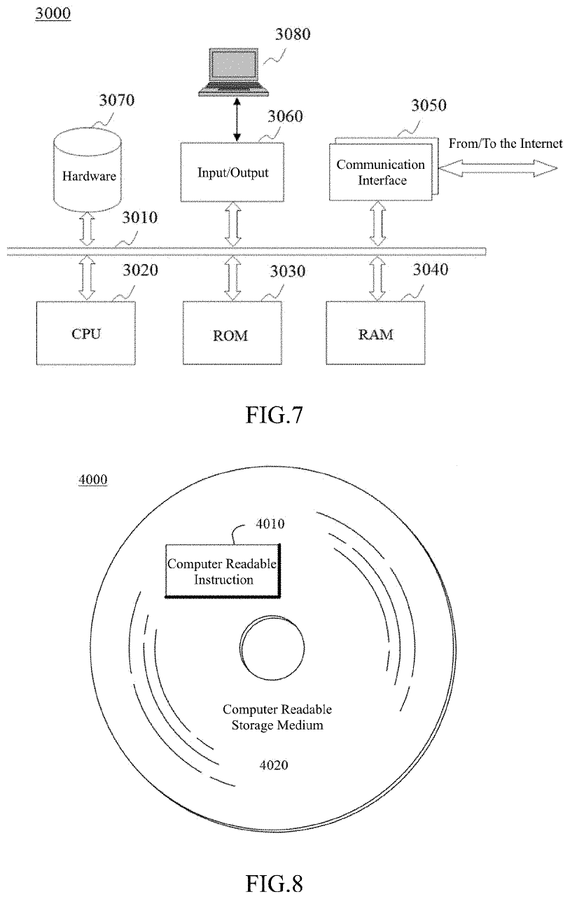

The method or device according to the embodiments of the present disclosure may also be implemented by means of an architecture of a computing equipment 3000 shown in FIG. 7. As shown in FIG. 7, the computing equipment 3000 may include a bus 3010, one or more CPU 3020, a Read Only Memory (ROM) 3030, a Random Access Memory (RAM) 3040, a communication port 3050 connected to a network, an input/output component 3060, a hard disk 3070, etc. The storage equipment in the computing equipment 3000, such as the ROM 3030 or the hard disk 3070, can store various data or files in the processing and/or communication in the method for generating the three-dimensional space of the target house provided by the present disclosure and program instructions executed by the CPU. The computing equipment 3000 may also include a user interface 3080. The architecture shown in FIG. 7 is without doubt only exemplary, and when different equipments are operated, one or more components in the computing equipment shown in FIG. 7 maybe omitted according to actual needs.

According to yet another aspect of the present disclosure, a computer-readable storage medium is also provided. FIG. 8 illustrates a schematic diagram 4000 of a storage medium according to the present disclosure.

As shown in FIG. 8, computer readable instructions 4010 are stored on a computer readable storage medium 4020. When the computer readable instructions 4010 are executed by a processor, the method for generating a three-dimensional space of a target house according to an embodiment of the present disclosure described with reference to the above drawings may be executed. The computer-readable storage medium includes, but is not limited to, a volatile memory and/or a nonvolatile memory, for example. The volatile memory may, for example, include a Random Access Memory (RAM) and/or a cache memory, etc. The nonvolatile memory may include, for example, a Read-Only Memory (ROM), a hard disk, a flash memory, etc.

It can be understood by those skilled in the art that many variations and improvements may be made to the contents disclosed in this disclosure. For example, the various equipments or components described above may be realized by a hardware, a software, a firmware, or a combination of part or all of the three.

In addition, although the present disclosure makes various references to some units in the system according to embodiments of the present disclosure, any number of different units may be used and run on the client and/or server. The units are illustrative only, and different units may be used for different aspects of the system and method.

Those of ordinary skill in the art can understand that all or part of the steps in the above method may be completed by instructing related hardware through a program, and the program may be stored in a computer-readable storage medium, such as a Read-Only Memory, a magnetic disk or an optical disk. Optionally, all or part of the steps of the above embodiments may also be implemented by using one or more integrated circuits. Accordingly, each module/unit in the above embodiments may be realized in the form of hardware or in the form of software functional modules. The present disclosure is not limited to any particular form of combination of hardware and software.

Unless otherwise defined, all terms (including technical and scientific terms) used herein have the same meanings as commonly understood by those of ordinary skill in the art to which this disclosure belongs. It should also be understood that terms such as those defined in general dictionaries should be interpreted as having meanings consistent with those in the context of related art, and should not be interpreted in an idealized or extremely formal sense unless explicitly defined here.

The above is a description of the present disclosure, and should not be considered as a limitation of the present disclosure. Although several exemplary embodiments of the present disclosure are described, those skilled in the art will readily understand that many modifications may be made to the exemplary embodiments without departing from the novel teaching and advantages of the present disclosure. Therefore, all such modifications are intended to be included in the scope of the disclosure as defined by the claims. It should be understood that the above is a description of the present disclosure, and should not be regarded as limited to the specific embodiments disclosed, and modifications to the disclosed embodiments and other embodiments are intended to be included in the scope of the appended claims. The present disclosure is defined by the claims and their equivalents.

What is claimed is:

1. A method for generating a three-dimensional space of a target house, comprising:
acquiring a two-dimensional floor plan of a target house corresponding to a displayed real three-dimensional floor plan scene, wherein the two-dimensional floor plan includes at least one area;
for each area of the at least one area, determining wall body information corresponding to the area;
constructing a three-dimensional subspace corresponding to the area based on the wall body information corresponding to the area; and
generating a three-dimensional space corresponding to the target house based on the two-dimensional floor plan and the three-dimensional subspace corresponding to each area of the at least one area.

2. The method according to claim 1, wherein the wall body information corresponding to the area includes: thickness information and height information of a wall body which constitutes the three-dimensional subspace corresponding to the area,
wherein the constructing the three-dimensional subspace corresponding to the area based on the wall body information corresponding to the area comprises:
constructing the three-dimensional subspace corresponding to the area based on the thickness information and the height information of the wall body that constitutes the three-dimensional subspace.

3. The method according to claim 2, wherein the constructing the three-dimensional subspace corresponding to the area comprises:
for each wall body for defining the three-dimensional subspace, determining three-dimensional vertex coordinates of the wall body in a three-dimensional coordinate system based on the thickness information and height information of the wall body.

4. The method according to claim 3, wherein the constructing the three-dimensional subspace corresponding to the area further comprises:
acquiring hollow data of a hollow in the three-dimensional subspace, wherein the hollow data comprises height, size and attachment information of the hollow;
determining an attached wall body where the hollow is located in the three-dimensional subspace based on the attachment information of the hollow; and
establishing three-dimensional vertex coordinates of the hollow in the three-dimensional coordinate system based on the three-dimensional vertex coordinates of the determined attached wall body and the height and size of the hollow,
wherein the hollow is at least one of a door, a window and a TV wall.

5. The method according to claim 1, wherein the two-dimensional floor plan includes an independent area, and the generating a three-dimensional space corresponding to the target house based on the two-dimensional floor plan and the three-dimensional subspace corresponding to each area of the at least one area comprises:
determining the three-dimensional subspace corresponding to the independent area as the three-dimensional space.

6. The method according to claim 1, wherein the two-dimensional floor plan includes a plurality of areas, and the generating a three-dimensional space corresponding to the target house based on the two-dimensional floor plan and the three-dimensional subspace corresponding to each of the at least one area comprises:
determining adjacent first area and second area for the plurality of areas, wherein the adjacent first area and second area share a connecting wall body; and
splicing the three-dimensional subspace corresponding to the first area and the three-dimensional subspace corresponding to the second area based on the connecting wall body to generate a three-dimensional space corresponding to the target house.

7. The method according to claim 1, further comprising:
acquiring wall surface decoration information; and
setting attribute information of a wall surface in the three-dimensional space as an updated three-dimensional floor plan scene of the target house based on the wall surface decoration information, wherein the wall surface decoration information includes: wall surface information and decoration information, wherein the wall surface information is used for indicating the wall surface to which the decoration information is applied.

8. The method according to claim 1, further comprising:
acquiring furniture decoration information; and
setting arrangement information of furniture in the three-dimensional space as an updated three-dimensional floor plan scene of the target house based on the furniture decoration information, wherein the furniture decoration information includes: furniture coordinate information and furniture style information.

9. The method according to claim 8, further comprising:
acquiring furniture operation information; and
performing an operation on the furniture corresponding to the furniture operation information as an updated three-dimensional floor plan scene of the target house based on the furniture operation information, wherein the operation comprises at least one of: deletion, movement and replacement.

10. The method according to claim 7, further comprising:
storing data of the updated three-dimensional floor plan scene of the target house.

11. A device for generating a three-dimensional space of a target house, comprising:
an acquiring unit, configured to acquire a two-dimensional floor plan of the target house corresponding to the displayed real three-dimensional floor plan scene, wherein the two-dimensional floor plan includes at least one area;
a determining unit, configured to determine, for each area of the at least one area, wall body information corresponding to the area;
a constructing unit, configured to construct a three-dimensional subspace corresponding to the area based on the wall body information corresponding to the area; and
a generating unit, configured to generate a three-dimensional space corresponding to the target house based on the two-dimensional floor plan and the three-dimensional subspace corresponding to each area of the at least one area.

12. The device according to claim 11, wherein the wall body information corresponding to the area includes: thickness information and height information of a wall body that constitutes the three-dimensional subspace corresponding to the area; and
wherein the construction unit is configured to construct the three-dimensional subspace corresponding to the area based on the thickness information and height information of the wall body that constitutes the three-dimensional subspace.

13. The device according to claim 12, wherein the construction unit constructing the three-dimensional subspace corresponding to the area comprises:
for each wall body for defining the three-dimensional subspace, determining three-dimensional vertex coordinates of the wall body in a three-dimensional coordinate system based on the thickness information and height information of the wall body.

14. The device according to claim 13, wherein the construction unit is further configured to:
acquire hollow data of a hollow in the three-dimensional subspace, wherein the hollow data comprises height, size and attachment information of the hollow;
determine an attached wall body where the hollow is located in the three-dimensional subspace based on the attachment information of the hollow;
establish three-dimensional vertex coordinates of the hollow in the three-dimensional coordinate system based on the three-dimensional vertex coordinates of the determined attached wall body and the height and size of the hollow; and
wherein the hollow is at least one of a door, a window and a TV wall.

15. The device according to claim 11, wherein the two-dimensional floor plan includes an independent area, and the generating unit is configured to:
determine the three-dimensional subspace corresponding to the independent area as the three-dimensional space.

16. The device according to claim 11, wherein the two-dimensional floor plan includes a plurality of areas, and the generating unit is configured to:
determine adjacent first area and second area for the plurality of areas, wherein the adjacent first area and the second area share a connecting wall body; and
splice the three-dimensional subspace corresponding to the first area and the three-dimensional subspace corresponding to the second area based on the connecting wall body to generate a three-dimensional space corresponding to the target house.

17. The device according to claim 11, further comprising a wall surface decoration unit configured to:
acquire wall surface decoration information; and
set attribute information of the wall surface in the three-dimensional space as an updated three-dimensional floor plan scene of the target house based on the wall surface decoration information, wherein the wall surface decoration information includes: wall surface information and decoration information, wherein the wall surface information is used for indicating the wall surface to which the decoration information is applied.

18. The device according to claim 11, further comprising a furniture decoration unit configured to:
acquire furniture decoration information; and
set arrangement information of furniture in the three-dimensional space as an updated three-dimensional floor plan scene of the target house based on the furniture decoration information, wherein the furniture decoration information includes: furniture coordinate information and furniture style information.

19. An equipment for generating a three-dimensional space of a target house, comprising:
one or more processors; and
one or more memories, wherein computer readable codes are stored in the memories, and when the computer readable codes are run by the one or more processors, the computer readable codes execute the method for generating a three-dimensional space of a target house according to claim 1.
